(19) United States
(12) Patent Application Publication
(10) Pub. No.: US 2023/0171402 A1
(43) Pub. Date: Jun. 1, 2023

(54) METHOD AND SYSTEM FOR VIDEO ENCODING GUIDED BY HYBRID VISUAL ATTENTION ANALYSIS

(71) Applicant: VASTAI TECHNOLOGIES (SHANGHAI) CO., LTD., Shanghai City (CN)

(72) Inventors: Xihe GAO, Aurora (CA); Lei ZHANG, Richmond Hill (CA)

(21) Appl. No.: 17/995,725

(22) PCT Filed: Apr. 9, 2021
(86) PCT No.: PCT/CA2021/050474

§ 371 Date: Oct. 7, 2022

Related U.S. Application Data
(60) Provisional application No. 63/007,950, filed on Apr. 10, 2020.

(51) Int. Cl. H04N 19/115; H04N 19/172; H04N 19/136

(52) U.S. Cl. CPC H04N 19/115; H04N 19/136; H04N 19/172

(57) ABSTRACT

A method and system for video encoding systems guided by hybrid visual attention analysis. The method comprises takes video frames as inputs and generate two saliency maps from bottom-up and top-down attention analysis respectively. The saliency maps are combined into a unified map used to conduct bit allocation in video encoding systems to reduce encoded video bandwidth while at the same time preserving the same or even better visual quality.

### TECHNICAL FIELD

The disclosure herein relates to the field of video processing technology, and particularly, to video encoding methods and systems guided by hybrid visual attention analysis.

### BACKGROUND

There is a growing need for video content on internet. According to Cisco, video constitutes 72 percent of Internet traffic, and it will grow into 82 percent by 2022. To that end, it is essential to improve the industry’s video compression techniques with the target of reducing bandwidth requirement while maintaining the same or even better perceptual quality.

Although developing new video-encoding standards, such as Versatile Video Encoding (VVC), can promise better compression, the procedure is rather time-consuming and requires the updating of viewing devices. An alternative solution is to improve the encoding algorithm with existing standards, which can be adopted in industry with much less effort and waiting time.

### SUMMARY

One object of the present application is to provide video encoding methods and systems guided by hybrid visual attention analysis. According to one aspect of the present invention, the present invention provides a video encoding method guided by hybrid visual attention analysis. In one embodiment, the method comprising obtaining video frame information, and analyzing the saliency map of top-down attention (top-down saliency map) and the saliency map of bottom-up attention (bottom-up saliency map) respectively through deep neural networks, wherein the saliency map is an explicit two-dimensional map of visual saliency that can be used to determine salient regions and non-salient regions. The present invention then linearly combines the top-down saliency map and bottom-up saliency map and allocates bitrate to the salient regions and non-salient regions based on combined saliency map of the video frame.

Another aspect of the present invention provides a video encoding system guided by hybrid visual attention analysis, wherein the system at least comprising saliency map analysis unit for analyzing a top-down saliency map and bottom-up saliency map in video frame information through deep neural networks after obtaining the video frame information, wherein the saliency map can be used to determine salient regions and non-salient regions. The video encoding system also comprises saliency map combination unit for linearly combining the top-down saliency map and bottom-up saliency map, as well as video encoding allocation unit for allocating bitrate to the salient regions and non-salient regions based on combined saliency map of the video frame.

The present invention also provides a computer-readable storage medium having a computer program stored thereon, which can implement the operations of the above methods when the computer program is executed.

According to another aspect of the present invention, the present invention also provides an electronic device that includes one or more processors, and also includes a memory for storing executable instructions, and the one or more processors are configured to perform the operation of the above methods via the executable instructions.

### BRIEF DESCRIPTION OF THE DRAWINGS

FIG. 1 illustrates, in an example embodiment, an architecture of video encoding systems guided by hybrid visual attention analysis.

FIG. 2 illustrates, in an example embodiment, live broadcasting scenes generated by hybrid visual attention analysis.

FIG. 3 illustrates, in an example embodiment, football match scenes generated by hybrid visual attention analysis.

FIG. 4 illustrates, in an example embodiment, the processing for video coding method guided by hybrid visual attention analysis.

### DETAILED DESCRIPTIONS

In this inventory, we focus on video encoding systems with visual attention analysis. The human brain tends to prioritize visual data obtained from the real world to guide our gaze, which is known as selective attention mechanism. Given an image, certain salient regions may receive the most gazes, while non-salient regions could be virtually invisible to human observers. Using selective attention mechanism in video encoding systems allows more dedicate bit allocation among non-salient and salient regions: fewer bits can be used in non-salient regions to reduce bandwidth cost, and more bits in salient regions for visual quality gain.

Human visual attention can be categorized into two types: bottom-up and top-down attention. Bottom-up attention, also known as visual saliency-based attention, is driven by purely visual data. The regions with sufficiently discriminative features with respect to surrounding region can attract visual attention in a bottom-up manner. On the other hand, top-down attention is driven by human cognitive phenomena, such as knowledge, expectations, and the current task. For instance, it is more likely for car drivers to see gas stations in a street than other targets. The perceptual processing of human visual attention requires both bottom-up and top-down factors.

With the development of deep neural network (DNN), the computational models of bottom-up attention driven with DNN shown significant improvements over the classic models on well-established saliency benchmark datasets. Meanwhile, DNN opens new avenues for top-down attention analysis, and it can be solved as object detection tasks with pre-defined targets.

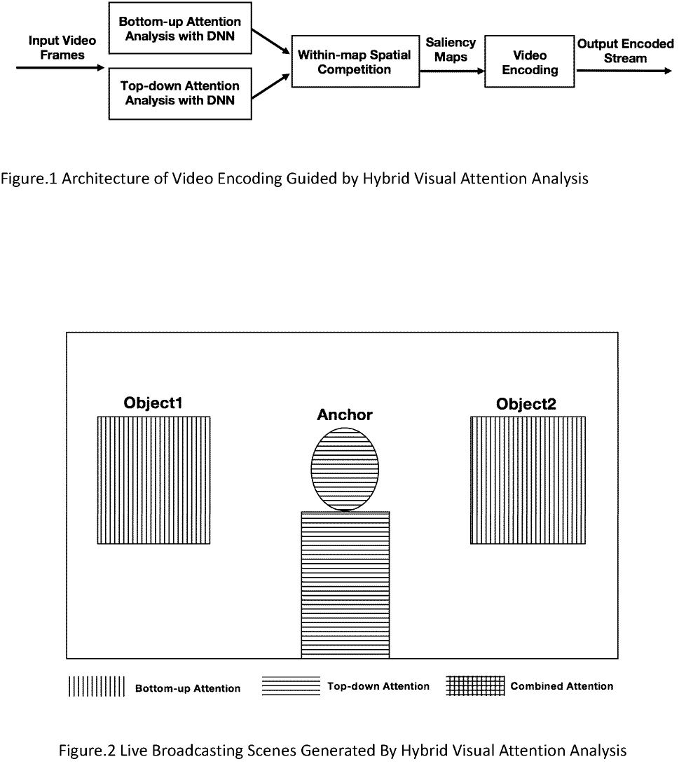

This invention introduces a novel video encoding algorithm guided by hybrid visual attention analysis, where visual attention is predicted with DNNs. The architecture of our framework is illustrated in FIG. 1. The method takes video frames as inputs and generate two saliency maps from bottom-up and top-down attention analysis respectively. Each saliency map is an explicit two-dimensional map that represents visual saliency of any location. Inspired by the human visual system, the saliency maps are linearly combined into a unified map, and it denotes the visual attention of human observers. To solve the signal-to-noise ratio problem during combination, we adopt a within-map spatial competition scheme which is realized by a two-dimensional difference-of-Gaussians filter. With the unified saliency map, we conduct bitrate allocation in video encoding systems to reduce encoded video bandwidth while at the same time preserving the same or even better visual quality.

The contribution of our invention is an end-to-end solution for video encoding systems guided by visual attention analysis where both bottom-up and top-down attention are considered. It is a general framework that allows the usage of any the-state-of-the-art deep learning methods for bottom-up and top-down visual attention analysis, where top-down attention can be addressed as object detection with pre-defined targets.

In FIG. 2, we demonstrate the application of our approach on live broadcasting scenes. Based on common sense, we assume that the target of top-down attention for live broadcasting scenes is person (anchor). Therefore, bottom-up attention analysis is to detect the targets with that differ from the surrounding environment by their unique features, such as colors, intensities, or orientations, and top-down attention analysis is to detect the anchor which is pre-defined with prior-knowledge. As shown in this example, the objects and anchor can be detected by bottom-up and top-down attention respectively. For the following step, the bit allocation of video encoding will be optimized in salient and non-salient regions for less bandwidth and satisfying visual perceptual quality.

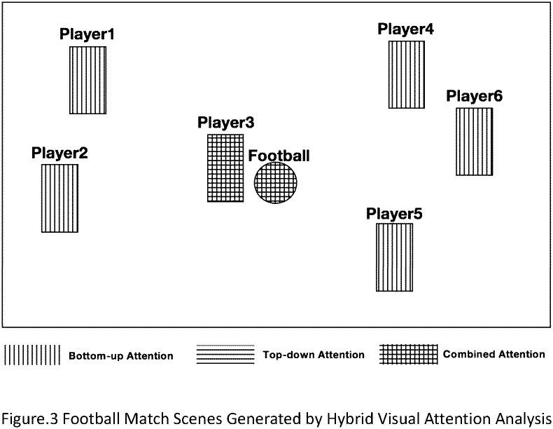

Another example of the application on football match scenes is given in FIG. 3. Since the audience prefers to follow the movement of football when watching football matches, we empirically set the target of football match scenes to football (surrounding region of football). In this case, bottom-up attention is able to catch all the players and footballs, while top-down attention emphasizes the football and its surrounding regions. Based on the prediction of visual attention, the encoding algorithm will assign more bits on all the players and footballs especially the football regions (football and player3) and less bits on the background regions which are non-salient.

Both FIG. 2 and FIG. 3 represent the combined visual attention maps from bottom-up and top-down visual attention analysis. These two types of visual attention analysis are independent with each other, so the outcome from the two analysis may or may not overlap depending on scenarios.

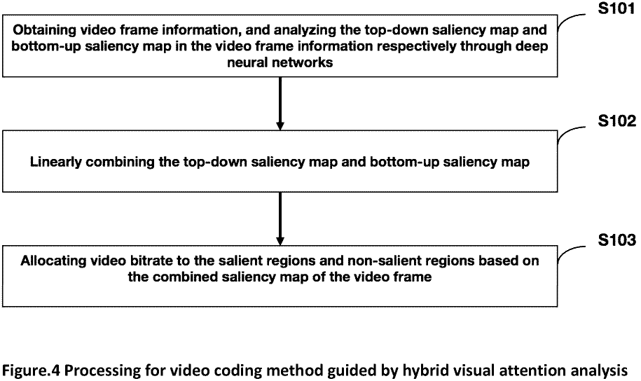

FIG. 4 describes the present invention that provides a video encoding method guided by hybrid visual attention analysis.

S101 in FIG. 4 shows obtaining video frame information and analyzing the top-down saliency map and bottom-up saliency map respectively through deep neural networks, wherein the saliency map is used to determine salient regions and non-salient regions.

Analyzing the top-down saliency map in the video frame information is through a deep neural network comprising: determining the saliency region map corresponding to the video frame in the current video depending on the type of the currently obtained video and the preset standard attention region corresponding to the current type of a video; wherein the types of the videos are divided according to factors including everyday life experience, video scenes and the like, such as TV drama videos, advertising videos, competitive games videos, lectures and training videos, etc. People watch different types of video contents; therefore, they pay more attention to different content. For example, TV drama videos will pay more attention to characters and actions, and competitive games videos will pay more attention to players and competition equipment, etc., and the region that people pay attention to in each type of video is used as the preset standard. After a current video frame is input into the deep neural network, identifying the type of the current video, and then determining regions that people pay attention to in the current video frame based on a preset standard attention region, and considering the region as the saliency region, and then determining a saliency map of the current video frame, that is, the top-down saliency map of the current video frame.

Analyzing the bottom-up saliency map in the video frame information is through a deep neural network comprising analyzing the intra-frame information of the current frame and the inter-frame information between the current frame and its adjacent frames based on the input multiframe images through the deep neural network, and determining the saliency map corresponding to the video frame in the current video; particularly, inputting multiple video frames to the deep neural network, and considering the multiple-scale features that contribute to bottom-up visual attention of human observers based on the information of the current frame and the difference information between the current frame and the adjacent frames through the deep neural network, and then determining the saliency map corresponding to the currently input multiple video frames, that is, the bottom-up saliency map of the current video frame.

S102 in FIG. 4 shows linearly combining the top-down saliency map and bottom-up saliency map. Particularly, the pixel in each saliency map includes a parameter value representing the degree of saliency. Both of the top-down saliency map and the bottom-up saliency map direct to the same video frame, and the parameter values of the corresponding pixel positions of the two are added to make the combination of the two saliency maps. More particularly, the parameter values corresponding to the pixels of the overlay saliency map will be normalized after the combination. Saliency regions and non-salient regions are defined with the saliency map through thresholding method. And the threshold value can be from either empirical estimate or users input.

S103 in FIG. 4 shows allocating bitrate to the salient regions and non-salient regions based on combined saliency map of the video frame. Particularly, the saliency map of the combined video frame is a superposition of the top-down and bottom-up saliency maps. The bitrate is allocated according to the superimposed saliency degree parameter corresponding to each pixel position in the combined saliency map. Generally, higher bitrate is allocated for larger saliency parameter value, while lower bitrate is allocated for smaller saliency parameter value.

In some embodiments, the saliency map is an explicit two-dimensional map that represents visual saliency corresponding to any position of a video frame. Particularly, the two-dimensional here refers to the rows and columns of the saliency map. Each saliency map has the same size as the video frame, and each pixel in the saliency map has a parameter value that represents the saliency degree of the pixel.

In some embodiments, two-dimensional difference-of-Gaussian filter is used to solve the signal-to-noise ratio problem during combination of saliency maps. Particularly, each saliency map is iteratively convolved by two-dimensional difference-of-Gaussian filter and then add the result to the original saliency map. The operation can increase the signal level while decrease the background noise level.

In some embodiments, S103 allocates more bits on the salient regions in the saliency map of the video frame; and/or allocates less bits on the non-salient regions in the saliency map of the video frame. Particularly, allocating more bits on the salient regions in the saliency map of the video frame can improve the visual quality of the salient regions; and allocating less bits on the non-salient regions in the saliency map of the video frame can reduce the storage space of the video stream and the bandwidth occupied during transmission without affecting the perceptual quality to human observers.

In some embodiments, it is contemplated that the video encoding systems guided by hybrid visual attention analysis disclosed herein may be implemented in one or more of a field-programmable gate array (FPGA) device, a graphics processing unit (GPU) device, a central processing unit (CPU) device, and an application- specific integrated circuit (ASIC).

It is contemplated that embodiments described herein be extended and applicable to individual elements and concepts described herein, independently of other concepts, ideas or system, as well as for embodiments to include combinations of elements in conjunction with combinations of steps recited anywhere in this application. Although embodiments are described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mention of the particular feature. Thus, any absence of describing combinations does not preclude the inventors from claiming rights to such combinations.

The present invention also provides a video encoding system guided by hybrid visual attention analysis, wherein the system comprising saliency map analysis unit for analyzing top-down saliency map and bottom-up saliency map respectively through deep neural networks after obtaining the video frame information, wherein the saliency map can be used to determine salient regions and non-salient regions.

Analyzing the top-down saliency map in the video frame information is through a deep neural network comprising determining the saliency region map corresponding to the video frame in the current video depending on the type of the currently obtained video and the preset standard attention region corresponding to the current type of a video. The types of the videos are divided according to factors including everyday life experience, video scenes and the like, such as TV drama videos, advertising videos, competitive games videos, lectures, and training videos, etc. People watch different types of video contents; therefore, they pay more attention to different content. For example, TV drama videos will pay more attention to characters and actions, and competitive games videos will pay more attention to players and competition equipment, etc., and the region that people pay attention to in each type of video is used as the preset standard. After a current video frame is input into the deep neural network, identifying the type of the current video, and then determining regions that people pay attention to in the current video frame based on a preset standard attention region, and considering the region as the saliency region, and then determining a saliency map of the current video frame, that is, the top-down saliency map of the current video frame.

Analyzing the bottom-up saliency map in the video frame information is also through a deep neural network comprising analyzing the intra-frame information of the current frame and the inter-frame information between the current frame and its adjacent frames based on the input multiframe images through the deep neural network, and determining the saliency map corresponding to the video frame in the current video; particularly, inputting multiple video frames to the deep neural network, and considering the multiple-scale features that contribute to bottom-up visual attention of human observers based on the information of the current frame and the difference information between the current frame and the adjacent frames through the deep neural network, and then determining the saliency region map corresponding to the currently input multiple video frames, that is, the bottom-up saliency map of the current video frame.

The video encoding system also consists of a saliency map combination unit for linearly combining the top-down saliency map and bottom-up saliency map. Particularly, the pixel in each saliency map includes a parameter value representing the degree of saliency. Both of the top-down saliency map and the bottom-up saliency map direct to the same video frame, and the parameter values of the corresponding pixel positions of the two are added to make the combination of the two saliency maps. More particularly, the parameter values corresponding to the pixels of the overlay saliency map will be normalized after the combination. Saliency regions and non-salient regions are defined with the saliency map through thresholding method. And the threshold value can be from either empirical estimate or users input.

The video encoding system also consists of a video encoding allocation unit for allocating bitrate to the salient regions and non-salient regions based on combined saliency map of the video frame, wherein, the saliency map of the combined video frame is a superposition of the top-down and bottom-up saliency maps. The encoding is allocated according to the superimposed saliency degree parameter corresponding to each pixel position in the combined saliency map. Generally, higher bitrate is allocated for larger saliency parameter value, while lower bitrate is allocated for smaller saliency parameter value.

The present invention also provides a computer-readable storage medium having a computer program stored thereon, which can implement the operations of the above methods when the computer program is executed.

The present invention also provides an electronic device, the electronic device at least comprising: one or more processors; and a memory for storing executable instructions; wherein the one or more processors are configured to perform the operation of the above methods via the executable instructions.

It should be noted that this invention can be implemented in software and/or a combination of software and hardware. For example, it can be implemented using an application specific integrated circuit (ASIC), a general-purpose computer or any other similar hardware device. In one embodiment, the software program of the present invention may be executed by a processor to realize the steps or functions described above. Similarly, the software program (including related data structure) of the present invention can be stored in a computer-readable recording medium, for example, RAM memory, magnetic or optical drive or floppy disk and similar devices. In addition, some steps or functions of the present application may be implemented by hardware, for example, as a circuit that cooperates with a processor to execute each step or function.

In addition, a part of the present application can be applied as a computer program product, such as a computer program instruction, which can invoke or provide the method and/or technical solution according to the present application through the operation of the computer when executed by a computer. Those skilled in the art will appreciate that the existing form of computer program instructions in computer-readable media includes, but is not limited to, source files, executable files, installation package files, etc. Accordingly, the manner that a computer program instruction is executed by a computer includes, but is not limited to: the computer directly executes the instruction, or the computer compiles the instruction and then executes the corresponding compiled program, or the computer reads and executes the instruction, or the computer reads and installs the instruction and then executes the corresponding post-installation program. Here, the computer-readable medium may be any available computer-readable storage medium or communication medium that can be accessed by a computer.

The communication medium includes a medium in which communication signals containing, for example, computer-readable instructions, data structures, program modules, or other data are transmitted from one system to another system. The communication media can include conductive transmission media (such as cables and wires (for example, optical fiber, coaxial, etc.)) and wireless (unguided transmission) media that can propagate energy waves, such as sound, electromagnetic, RF, microwave, and infrared. Computer readable instructions, data structures, program modules or other data may be embodied as, for example, a modulated data signal in a wireless medium such as a carrier wave or similar mechanism (such as embodied as part of spread spectrum technology). The term “modulated data signal” refers to a signal whose one or more characteristics have been altered or set in such a way as to encode information in the signal. Modulation can be analog, digital, or hybrid modulation techniques.

By way of example and not limitation, the computer-readable storage medium may include volatile and non-volatile, removable and non-removable medium implemented in any method or technology for storing information such as computer-readable instructions, data structures, program modules, or other data. For example, computer-readable storage media include, but are not limited to, volatile memory, such as random access memory (RAM, DRAM, SRAM); and non-volatile memory, such as flash memory, various read-only memories (ROM, PROM, EPROM) , EEPROM), magnetic and ferromagnetic/ferroelectric memory (MRAM, FeRAM); and magnetic and optical storage devices (hard disks, tapes, CDs, DVDs); or other currently known media or future-developed media that can store computer readable information/data for use by computer systems.

Here, according to one embodiment of the present invention, the present invention provides a device that includes a memory for storing computer program instructions and one or more processors for performing the computer program instruction. Wherein, when the computer program instruction is executed by the one or more processors, the device is triggered to operate the method and/or technical solution according to the foregoing multiple embodiments of the present invention.

What is claimed is:

1. A video encoding method guided by hybrid visual attention analysis, comprising:
a. obtaining video frame information, and analyzing the top-down saliency map and bottom-up saliency map respectively through deep neural networks, wherein the saliency map can be used to determine salient regions and non-salient regions;
b. linearly combining the top-down saliency map and bottom-up saliency map; and
c. allocating bitrate to the salient regions and non-salient regions based on combined saliency map of the video frame.

2. A method of claim 1, wherein analyzing the top-down saliency map in the video frame information through a deep neural network comprising:
determining the saliency map corresponding to the video frame in the current video depending on the type of the currently obtained video and the preset standard attention region corresponding to the current type of a video.

3. A method of claim 1, wherein analyzing the bottom-up saliency map in the video frame information through a deep neural network comprising:
analyzing the intra-frame information of the current frame and the interframe information between the current frame and its adjacent frames based on the input video frames through the deep neural network and determining the saliency map corresponding to the video frame in the current video.

4. A method of claim 1, wherein the saliency map is an explicit two-dimensional map that represents visual saliency corresponding to any position of a video frame.

5. A method of claim 1, wherein two-dimensional difference-of-Gaussians approach is used to solve the signal-to-noise ratio problem during combination.

6. A method of claim 1, wherein step c comprising:
allocating more bits on the salient regions in the saliency map of the video frame; and/or allocating less bits on the non-salient regions in the saliency map of the video frame.

7. A video encoding system guided by hybrid visual attention analysis, wherein the system comprising:
saliency map analysis unit for analyzing a top-down saliency map and bottom-up saliency map respectively through deep neural networks after obtaining the video frame information, wherein the saliency map can be used to determine salient regions and non-salient regions;
saliency map combination unit for linearly combining the top-down saliency map and bottom-up saliency map; and
video encoding allocation unit for allocating video bitrate to the salient regions and non-salient regions based on combined saliency map of the video frame.

8. A computer-readable storage medium, wherein the computer-readable storage medium comprises a computer program stored thereon, and wherein the computer program can implement the video encoding methods guided by hybrid visual attention analysis according to any one of claims 1-7 when the computer program is executed.

9. An electronic device, at least comprising:
one or more processors; and
a memory for storing executable instructions;
wherein the one or more processors are configured to perform the video encoding methods guided by hybrid visual attention analysis according to any one of claims 1-7 via the executable instructions.

10. A method of hybrid visual attention analysis for video encoding systems,
the method comprising:
A bottom-up attention analysis method to generate a visual saliency map;
A top-down attention analysis method to generate a visual saliency map; and
The saliency maps are linearly combined into a unified map, and it denotes the visual attention of human observers.

11. A method of claim 10 wherein each saliency map is an explicit two-dimensional map that represents visual saliency of any location.

12. A method of claim 10 wherein a within-map spatial competition scheme realized by a two-dimensional difference-of-Gaussians approach is used to solve the signal-to-noise ratio problem during combination.

13. A method of claim 10 wherein the combined unified saliency map is used to conduct bit allocation in video encoding systems to reduce encoded video bandwidth while at the same time preserving the same or even better visual quality.

14. A method of claim 10 wherein any state-of-the-art methods for bottom-up and top-down visual attention analysis can be used, where top-down attention can be addressed as object detection with pre-defined targets, and bottom-up attention also known as saliency-based attention, is driven by purely visual data.
